(19) United States
(12) Patent Application Publication
(10) Pub. No.: US 2018/0307851 A1
(43) Pub. Date: Oct. 25, 2018

(54) Method and System to Sanitize, Recover, Analyze and Wipe Data Stored on Non-Transitory Memory Devices Connected to a Dedicated Embedded Microcomputer System with a Network Connection

(71) Applicant: IoT Cloud Technologies Inc., Calgary (CA)

(72) Inventor: Matthew James Lewis, Calgary (CA)

(21) Appl. No.: 15/953,095

(22) Filed: Apr. 13, 2018

Related U.S. Application Data
(60) Provisional application No. 62/485,026, filed on Apr. 13, 2017.

(51) Int. Cl. G06F 21/62; G06F 13/38; G06F 21/44; G06F 21/56; H04L 29/06; G06F 11/14

(52) U.S. Cl. CPC G06F 21/62; G06F 13/382; G06F 21/44; G06F 3/0482; H04L 63/0876; G06F 11/1458; G06F 2213/0042; G06F 21/568

(57) ABSTRACT

A Dedicated Embedded Microcomputer Analyzer Sanitizer mounts a USB memory device or other non-volatile memory device on a dedicated microcomputer under restricted file permissions, and features a network connection for connecting said dedicated microcomputer to a network. The Analyzer Sanitizer displays its IP address or hostname when connected to the network, and hosts a web interface accessible by entering the IP address or hostname into a web browser of any computer connected to said network, thereby isolating said computer from any malicious self-executing software on the non-volatile memory. The web interface includes selectable options for downloading, uploading, wiping, recovering or analyzing data content on the non-volatile memory.

### CROSS REFERENCE TO RELATED APPLICATIONS

This application claims benefit under 35 U.S.C. 119(e) of U.S. Provisional Patent Application No. 62/485,026, filed Apr. 13, 2017, the entirety of which is incorporated herein by reference.

### FIELD OF THE INVENTION

The present invention relates generally to computer security, and more particularly devices and techniques for preventing malicious software on a non-volatile memory device from being executed by a computer for which other contents of said non-volatile memory are destined.

### BACKGROUND

As a course of regular business medical offices, hospitals, law offices and other businesses receive USB memory devices containing images or documents that are intended to be viewed on or copied to a destination computer owned and operated by such business. The problem with plugging a USB memory device into the destination computer is that the memory device could contain harmful software that automatically executes on the computer.

Accordingly, there is a need for solutions by which content from USB memory devices and other non-volatile memory devices can be safely accessed without exposing the destination computer to potential malicious content.

### SUMMARY OF THE INVENTION

According to a first aspect of the invention, there is provided a device comprising: a dedicated microcomputer;
at least one connector by which a non-volatile memory device can be plugged into connection with the dedicated microcomputer under restricted file permissions;
a network connection by which the dedicated microcomputer is connectable to a network and accessible therethrough via an IP address or hostname; and
a display operable to display the IP address or hostname of the dedicated microcomputer on said network when connected thereto, whereby a user reading said IP address or hostname from said display can visit said IP address or hostname in a web browser of another computer on said network;
wherein the dedicated microcomputer is configured to host a web interface accessible through said IP address or hostname and by which selectable options concerning content of the non-volatile memory device are presentable in said web browser.

Preferably said selectable options presented in the web interface include one or more of: a download option for downloading files from the non-volatile memory device through the network, a file recovery option for recovering deleted files from said non-volatile memory device; a memory wipe option for wiping all data from said non-volatile memory device; and an upload option for uploading files to said non-volatile memory device.

Preferably the at least one connector comprises multiple connectors by which different types of non-volatile memory devices are pluggable into connection with the dedicated microcomputer.

Preferably the at least one connector includes a USB connector.

Preferably the at least one connector includes a SATA connector and power connector.

Preferably the at least one connector includes an eSATA connector.

According to a second aspect of the invention, there is provided a system comprising a plurality of devices of the type recited under the first aspect of the invention, each having a respective identifier assigned thereto, and a cloud computing system with which said plurality of devices are communicable through said network, said cloud computing system hosting a cloud computing web interface through which each of said plurality of devices is accessible using the respective identifier assigned thereto.

Preferably each of said plurality of devices is configured to display the respective identifier thereof together with the IP address or hostname thereof.

Said respective identifier may be, for example, a serial number of MAC address of said device.

According to third aspect of the invention, there is provided a method of establishing or enabling indirect access to a non-volatile memory device by a computer, said method comprising: (a) in either order, (i) establishing a restricted privilege connection between said non-volatile memory device and a dedicated microcomputer device that is separate from said computer; and (ii) with said dedicated micro-computer device connected to a network, displaying on said dedicated micro-computer device an IP address or hostname by which said dedicated micro-computer device is identifiable on said network; and (b) through operation of said dedicated micro-computer device hosting a web interface that is accessible through said IP address or hostname and presents user-selectable options concerning content of the non-volatile memory device.

In one embodiment, the method includes an additional step of reading said IP address or hostname from said display.

In such instance, the method preferably includes an additional step of, in a web browser of said computer, using said IP address or hostname to access a web interface that is hosted by said dedicated micro-computer device and presents user-selectable options concerning content of the non-volatile memory device.

In another embodiment, step (a)(ii) of the method includes displaying an additional identifier of said dedicated microcomputer device along with said IP address or hostname, and step (b) includes, through said network, communicating said dedicated microcomputer device with a cloud computing system having a cloud computing web interface through which said dedicated microcomputer device is accessible using said identifier, thereby providing access through said cloud computing web interface to at least some of said selectable options concerning content of the non-volatile memory device.

Said additional identifier may be, for example, a serial number of MAC address of said dedicated microcomputer device.

Preferably said selectable options presented in the web interface include one or more of: a download option for downloading files from the non-volatile memory device through the network, a file recovery option for recovering deleted files from said non-volatile memory device; a memory wipe option for wiping all data from said non-volatile memory device; and an upload option for uploading files to said non-volatile memory device.

According to a fourth aspect of the invention, there is provided a method of indirectly accessing a non-volatile memory device using a computer, said method comprising: (a) in either order, (i) connecting said non-volatile memory device, under restricted file permissions, to a dedicated microcomputer device that is separate from said computer; and (ii) with said dedicated micro-computer device connected to a network, reading from a display of said dedicated micro-computer device an IP address or hostname by which said dedicated micro-computer device is identifiable on said network; and (b) in a web browser of said computer, using said IP address or hostname to access a web interface that is hosted by said dedicated micro-computer device and presents user-selectable options concerning content of the non-volatile memory device.

The method may further include selecting a download option from the user-selectable options, and thereby downloading files from the non-volatile memory device to the computer through the network.

Alternatively, the method may further include selecting a file recovery option from the user-selectable options, and thereby recovering deleted files from said non-volatile memory device.

Alternatively, the method may further include selecting a memory wipe option from the user-selectable options, and thereby wiping all data from said non-volatile memory device.

Alternatively, the method may further include selecting an upload option from the user-selectable options, and thereby uploading files to said non-volatile memory device.

Alternatively, the method may further include selecting an ISO image option from the user-selectable options, and thereby imaging said non-volatile memory device to an ISO image file.

Alternatively, the method may further include selecting a restore ISO image option from the user-selectable options, and thereby restoring an ISO image to said non-volatile memory device.

The forgoing devices, systems and methods employing a Dedicated Embedded Microcomputer Analyzer Sanitizer overcome the aforementioned problems by mounting a USB memory device or other non-volatile memory device on a dedicated embedded computer under restricted file permissions so that the USB memory device cannot execute any auto install programs on a separate computer from which the dedicated embedded computer is controlled.

### BRIEF DESCRIPTION OF THE DRAWINGS

Preferred embodiments of the invention will now be described in conjunction with the accompanying drawings in which:

FIG. 1 Illustrates the Dedicated Embedded Microcomputer Analyzer Sanitizer.

FIG. 2 Illustrates the Dedicated Embedded Microcomputer Analyzer Sanitizer block diagram.

FIG. 3 Illustrates the Method for Scanning, Recovering, Analyzing, Imaging a Laptop or Desktop Computer.

FIG. 4 Shows the basic menu tool options of the Dedicated Embedded Microcomputer Analyzer Sanitizer.

FIG. 5 Illustrates the Dedicated Embedded Microcomputer Analyzer Sanitizer in an office environment.

FIG. 6 Illustrates the Dedicated Embedded Microcomputer Analyzer Sanitizer connected with a cloud computing system.

FIG. 7 Illustrates the Dedicated Embedded Microcomputer Analyzer Sanitizer connected to a Mobile device.

### DETAILED DESCRIPTION OF PREFERRED EMBODIMENTS

In one embodiment of the invention is a Dedicated Embedded Microcomputer Analyzer Sanitizer with a USB connection, network connection and display screen and optional SATA connection. The Dedicated Embedded Microcomputer Analyzer Sanitizer is plugged into an Ethernet connection and the IP address, hostname and serial number or MAC address of the Dedicated Embedded Microcomputer Analyzer Sanitizer is automatically displayed on the display screen. All the operational menus are accessible through a common web browser or dedicated APP by entering the IP address or hostname into the web address bar of the web browser or APP. For convenience, the term web browser is used generically to encompass both options of standard web browser or a dedicated app for accessing and navigating the web interface hosted by the Dedicated Embedded Microcomputer Analyzer Sanitizer at said IP address. The Memory Devices compatible with the Dedicated Embedded Microcomputer Analyzer Sanitizer include all types of Non-Volatile Memories including USB memory sticks, FLASH Memories, SSD, and HDs. The USB memory sticks are plugged into the USB connector on the Dedicated Embedded Microcomputer Analyzer Sanitizer. FLASH and Micro FLASH Memories are plugged into a USB adapter on the Dedicated Embedded Microcomputer Analyzer Sanitizer. Larger capacity memory devices including SSD, NVMe or mechanical HD are plugged directly through a SATA connection or through a USB interface on the Dedicated Embedded Microcomputer Analyzer Sanitizer. The non-volatile memory devices automatically mount under restricted file permissions. The file contents of the external Memory Device are displayed through the web browser connected to the IP address or hostname of the Dedicated Embedded Microcomputer Analyzer Sanitizer. Executable files are marked with appropriate warnings. File contents and or image files can be displayed through the web browser. Options are available to download files through the network, recover deleted files, wipe and upload files to the Memory Device. The web interface allows for complete configurations including network configurations of the Dedicated Embedded Microcomputer Analyzer Sanitizer. The analytics of the Dedicated Embedded Microcomputer Analyzer Sanitizer include image recognition, string searches, and cryptographic hash functions of data stored on the external memory devices.

In another embodiment a plurality of Dedicated Embedded Microcomputer Analyzers Sanitizers with the above features are connected through a computer network to Private or Public Cloud Computing Systems. The Cloud Computing Systems control the operation of the Dedicated Embedded Microcomputer Analyzer Sanitizers. The Dedicated Embedded Microcomputer Analyzer Sanitizer performs post processing of the recovered files. The Post processing of the recovered files includes string searches and cryptographic hash functions, to detect duplicate data and or uniquely identify files. Any selected one of the plurality of Dedicated Embedded Microcomputer Analyzers Sanitizers are monitored and controlled by pointing any browser to the IP address or hostname of the Cloud Computing Systems web interface, and entering the respective serial number of the selected Dedicated Embedded Microcomputer Analyzer Sanitizer into an identifier field of the cloud computing web interface to gain access to the operational menus of the selected Dedicated Embedded Microcomputer Analyzer Sanitizer. The Individual Dedicated Embedded Microcomputer Analyzers Sanitizers can also be controlled and monitored by pointing any browser directly to the Dedicated Embedded Microcomputer Analyzers Sanitizers IP address or hostname to gain access to the operational menus thereof. Dedicated Embedded Microcomputer Analyzers Sanitizers are operable to perform string searches and cryptographic hash functions locally. The results from the string searches and cryptographic hash functions are analyzed by the Cloud Computing Systems. Additionally, files including recovered files and or ISO images are compressible by the Dedicated Embedded Microcomputer Analyzers Sanitizers and then transferable to the Cloud Computing Systems for more detailed processing. The plurality of Dedicated Embedded Microcomputer Analyzers Sanitizers could be in one physical location or at multiple geographic locations with connections to the Cloud Computing System. Likewise, the Cloud Computing Systems could be in one physical location or at multiple geographic locations.

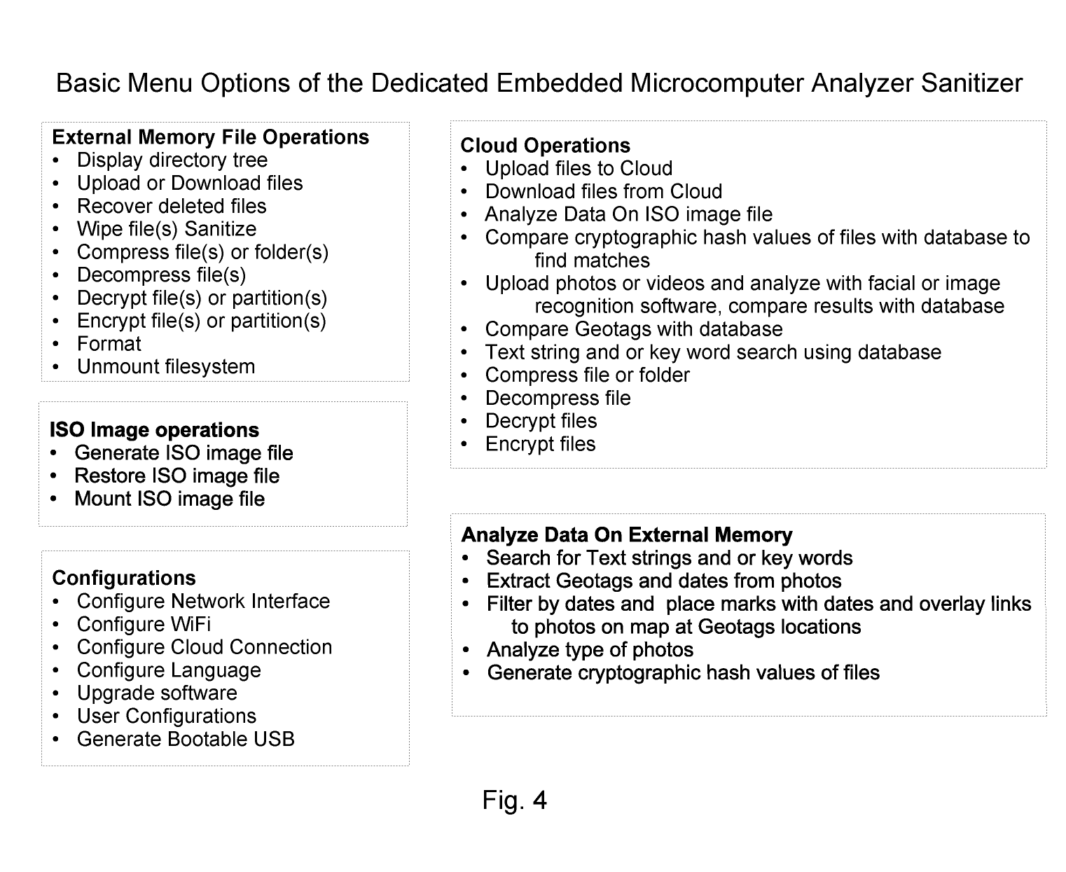

Once powered up and connected to a network, the Dedicated Embedded Microcomputer Analyzer Sanitizer (also referred to more concisely as the Analyzer Sanitizer) displays the respective IP address(es), hostname, serial number and MAC address assigned to the Analyzer Sanitizer. A laptop, desktop, tablet or smart phone hereafter referred to generically as a “computer” connects to the Analyzer Sanitizer. The functions of the Analyzer Sanitizer are controlled through a graphical user interface (GUI) displayed through a standard web browser or dedicated app on the computer. When an external memory device (Hard Disk, SSD or NVMe) is connected to the Analyzer Sanitizer through the USB adapter, SATA or eSATA or mounted through a network connection the Analyzer Sanitizer hosts a web interface displayable in the web browser or dedicated app to present the operational menu options outlined below and illustrated in FIG. 4.

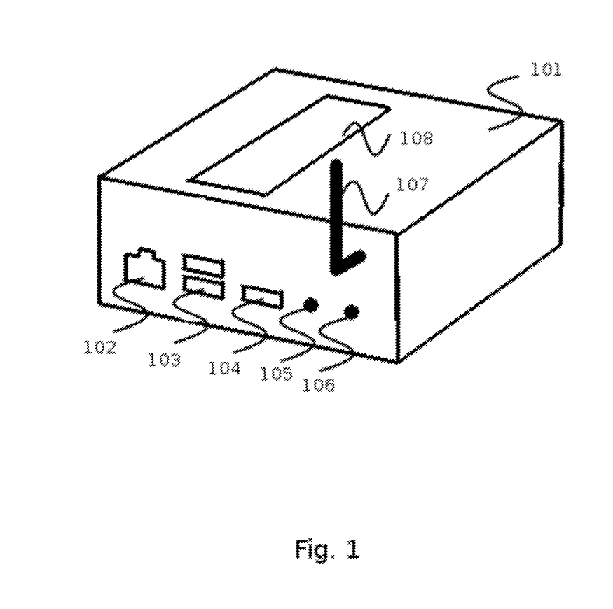

FIG. 1 Illustrates the Dedicated Embedded Microcomputer Analyzer Sanitizer. The positioning of the various connectors and display is for illustration purposes only. The Dedicated Embedded Microcomputer Analyzer Sanitizer (101) also referred to as Analyzer Sanitizer, is equipped with a display (108), RJ45 network interface and connector (102) one or more USB ports(s) connector(s) (103), power input connector (106), WiFi module and antenna (107), optional SATA/eSATA interface connector (104) and SATA power connector (105). When the Analyzer Sanitizer is powered and connected to a network the display indicates at least the IP address and/or hostname of the Analyzer Sanitizer on said network.

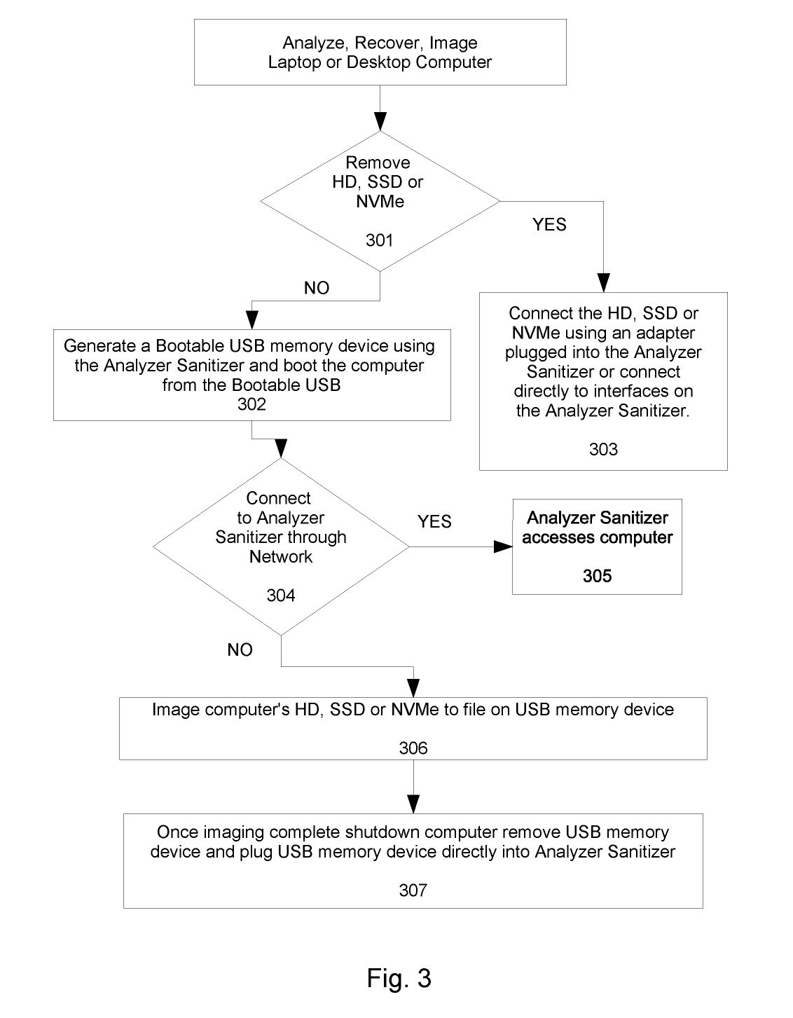

FIG. 2 Illustrates the Dedicated Embedded Microcomputer Analyzer Sanitizer block diagram. The Dedicated Embedded Microcomputer Analyzer Sanitizer, is equipped with a power supply (204), embedded microcomputer system (202), data storage (203), display (108), RJ45 network interface and connector (102) one or more USB interface(s) connector(s) (103), power input connector (106), WiFi module and antenna (107), optional SATA/eSATA interface connector (104) and SATA power connector (105).

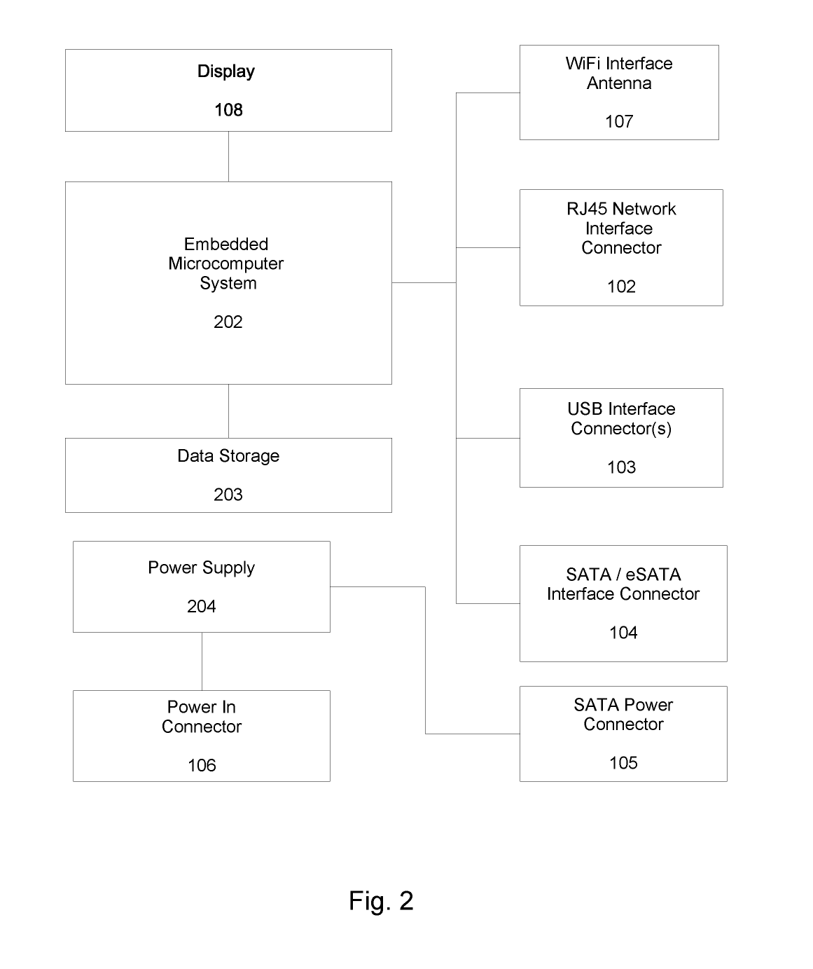

FIG. 3 Illustrates the Method for Scanning, Recovering, Analyzing, or Imaging a Laptop or Desktop Computer. In FIG. 3 The Dedicated Embedded Microcomputer Analyzer Sanitizer is referred to as Analyzer Sanitizer. If easily accessible, the Hard Disk, Solid-State Storage Device (SSD) or Non-Volatile Memory Express (NVMe) is removed from the Laptop or Desktop Computer (301). The Hard Disk, SSD or NVMe is then connected to the Analyzer Sanitizer through the USB adapter, SATA or eSATA interface on the Analyzer Sanitizer. If the Hard Disk, SSD or NVMe is not removed from the Laptop or Desktop Computer, then the Laptop or Desktop Computer is booted up using a bootable USB device (304) and connected to the LAN through a RJ45 network connector or WiFi network. If the Laptop or Desktop Computer is unable to connect to the LAN, then the Laptop or Desktop Computer is imaged onto the bootable USB memory device (306). Once imaging is complete the Laptop or Desktop Computer shuts down and the bootable USB memory device is unplugged from the Laptop or Desktop Computer and plugged directly into the Analyzer Sanitizer. If the Laptop or Desktop Computer is able to connect to the Analyzer Sanitizer through the LAN, then the Analyzer Sanitizer accesses the Non-Volatile Memory within the Laptop or Desktop Computer through the LAN as if it were connected directly to the Analyzer Sanitizer.

FIG. 4 Shows the basic tool menu options of the Dedicated Embedded Microcomputer Analyzer Sanitizer. The user logs into the Dedicated Embedded Microcomputer Analyzer Sanitizer through a separate computer (laptop, desktop, tablet or smart phone), and depending on the user privileges, the user can access some or all of the menu options. Depending on the end user's requirements, some of the features related to the cloud computing may be disabled.

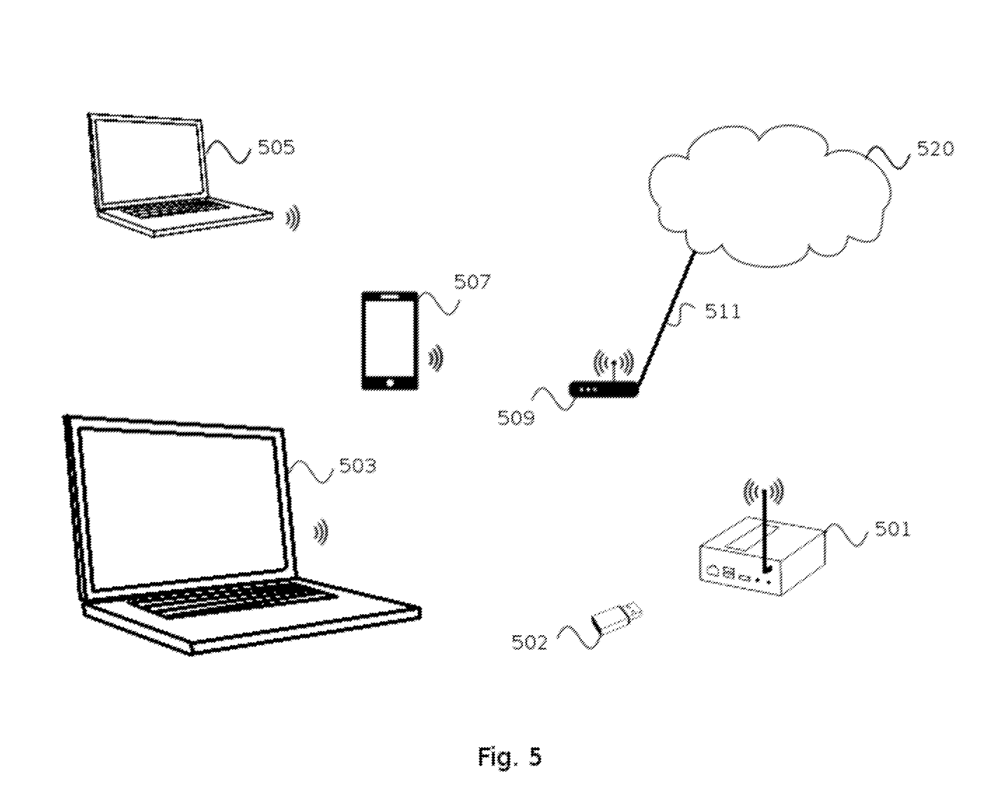

FIG. 5 Illustrates the Dedicated Embedded Microcomputer Analyzer Sanitizer (501) in an office environment with various computers (503, 505, and 507), the Dedicated Embedded Microcomputer Analyzer Sanitizer and a WiFi router (509) connected on a WiFi network. Note that the Laptops (503 or 505) and any desktops or servers (not shown in this illustration) can be connected through the wireless WiFi network and or through a wired network (not shown in this illustration). WiFi router (509) connects to the internet (520) through a broadband internet connection (511). The USB storage device (502) generally encompasses all types of USB storage devices, as well as adapters used to connect all types of Non-Volatile Memory Devices to a USB (Universal Serial Bus). The USB storage device (502) is plugged into the USB port on the Dedicated Embedded Microcomputer Analyzer Sanitizer (501). Once the USB storage device (502) is plugged into the USB port (FIG. 1—103) on the Dedicated Embedded Microcomputer Analyzer Sanitizer (501), the USB storage device (502) is mounted with restricted file permissions and users can login and access the files on the USB storage device (502) and additional menu options through the web interface accessed through the web browser or app.

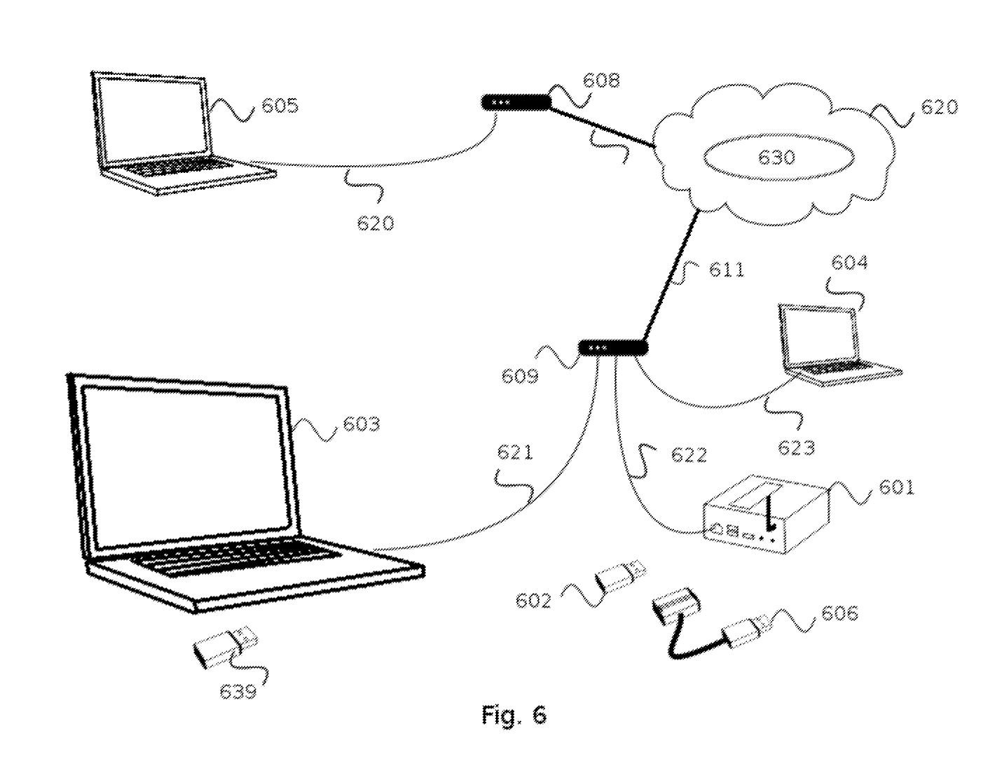

FIG. 6 Illustrates the Dedicated Embedded Microcomputer Analyzer Sanitizer (601) connected with a Cloud Computing System (630). In this illustration Firewalls and or VPN Routers (609-608) are connected to wired networks (620, 621, 622, 623), Laptops (605, 604, 603) and the Dedicated Embedded Microcomputer Analyzer Sanitizer (601). Note that the Laptops (605, 604, 603) and any desktops or servers (not shown in this illustration) can be connected through the wired network and or through a wireless WiFi (not shown in this illustration). The Cloud Computing System (630) is a Public or Private Cloud either accessed through the internet (620) and/or on a Private Network. The Dedicated Embedded Microcomputer Analyzer Sanitizer (601) is configured using one of the Laptops (603, 604), or if the Firewalls are also VPN Routers (609-608), then the Dedicated Embedded Microcomputer Analyzer Sanitizer (601) can be configured through the Laptop (605) or any other computer on the same network. Part of the configuration of the Dedicated Embedded Microcomputer Analyzer Sanitizer (601) includes enabled access to the operational menu thereof via a cloud computing web interface hosted at the IP address or hostname of the Cloud Computing System (630). By accessing the cloud computing web interface and entering the serial number or other unique identifier of the Analyzer Sanitizer, the user can access the web interface hosted at the IP address of said Analyzer Sanitizer. The Cloud Computing System (630) is thus allowed to monitor and control the operation of each Dedicated Embedded Microcomputer Analyzer Sanitizer (601). Users with access to the Cloud Computing System (630) can login through a web browser or app to monitor or control the operation of individual or multiple Dedicated Embedded Microcomputer Analyzer Sanitizer(s). A USB storage device (602) can be plugged into the USB port (FIG. 1—103) on Dedicated Embedded Microcomputer Analyzer Sanitizer (601), or other types of Non-Volatile Memory Devices including Hard Disk, SSD or NVMe can be connected to the Dedicated Embedded Microcomputer Analyzer Sanitizer (601) through interface hardware (606) to the USB or SATA/eSATA interface connector (FIG. 1—104) and the SATA power connector (FIG. 1—105) if additional power is required. The Laptop (603) or any desktop or server (not shown in this illustration) on the same network as the Dedicated Embedded Microcomputer Analyzer Sanitizer (601) can be booted up using a bootable and preprogrammed USB storage device (639) as described in FIG. 3.

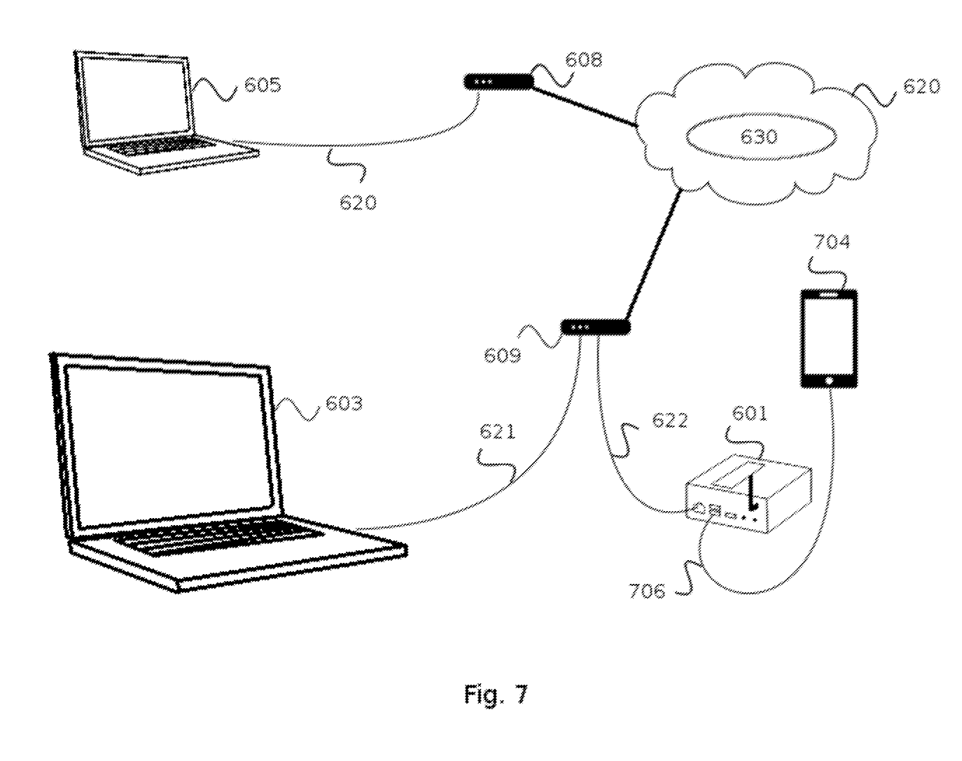

FIG. 7 Illustrates the Dedicated Embedded Microcomputer Analyzer Sanitizer connected to a Mobile device (704) (e.g. a Smart Phone or Tablet), that is connected to the Dedicated Embedded Microcomputer Analyzer Sanitizer (601) through a USB cable (706) and plugged into the USB port (FIG. 1—103). Once connected, the Dedicated Embedded Microcomputer Analyzer Sanitizer accesses the non-volatile memory within the Mobile device (704) as described in the above embodiments.

Since various modifications can be made in the disclosed invention as herein above described, and many apparently widely different embodiments of same made, it is intended that all matter contained in the accompanying specification shall be interpreted as illustrative only and not in a limiting sense.

1. A device comprising:
a dedicated microcomputer;
at least one connector by which a non-volatile memory device can be plugged into connection with the dedicated microcomputer under restricted file permissions;
a network connection by which the dedicated microcomputer is connectable to a network and accessible therethrough via an IP address or hostname; and
a display operable to display the IP address or hostname of the dedicated microcomputer on said network when connected thereto, whereby a user reading said IP address or hostname from said display can visit said IP address or hostname in a web browser of another computer on said network;
wherein the dedicated microcomputer is configured to host a web interface accessible through said IP address or hostname and by which selectable options concerning content of the non-volatile memory device are presentable in said web browser or app.

2. The device of claim 1 wherein said selectable options presented in the web interface include one or more of: a download option for downloading files from the non-volatile memory device through the network, a file recovery option for recovering deleted files from said non-volatile memory device; a memory wipe option for wiping all data from said non-volatile memory device; and an upload option for uploading files to said non-volatile memory device.

3. The device of claim 1 wherein the at least one connector comprises multiple connectors by which different types of non-volatile memory devices are pluggable into connection with the dedicated microcomputer.

4. The device of claim 1 wherein the at least one connector includes a USB connector.

5. The device of claim 1 wherein the at least one connector includes a SATA connector and power connector.

6. The device of 1 wherein the at least one connector includes an eSATA connector.

7. A system comprising a plurality of devices of the type recited in claim 1, each having a respective identifier assigned thereto, and a cloud computing system with which said plurality of devices are communicable through said network, said cloud computing system hosting a cloud computing web interface through which each of said plurality of devices is accessible using the respective identifier assigned thereto.

8. The system of claim 7 wherein each of said plurality of devices is configured to display the respective identifier thereof together with the IP address or hostname thereof.

9. A method of establishing or enabling indirect access to a non-volatile memory device by a computer, said method comprising: (a) in either order, (i) establishing a restricted privilege connection between said non-volatile memory device and a dedicated microcomputer device that is separate from said computer; and (ii) with said dedicated micro-computer device connected to a network, displaying on said dedicated micro-computer device an IP address or hostname by which said dedicated micro-computer device is identifiable on said network; and (b) through operation of said dedicated micro-computer device hosting a web interface that is accessible through said IP address or hostname and presents user-selectable options concerning content of the non-volatile memory device.

10. The method of claim 9 comprising reading said IP address or hostname from said display.

11. The method of claim 10 further comprising, in a web browser of said computer, using said IP address or hostname to access a web interface that is hosted by said dedicated micro-computer device and presents user-selectable options concerning content of the non-volatile memory device.

12. The method of claim 9 wherein step (a)(ii) comprises displaying an additional identifier of said dedicated microcomputer device along with said IP address or hostname, and step (b) comprises, through said network, communicating said dedicated microcomputer device with a cloud computing system having a cloud computing web interface through which said dedicated microcomputer device is accessible using said identifier, thereby providing access through said cloud computing web interface to at least some of said selectable options concerning content of the non-volatile memory device.

13. The method of claim 12 wherein said selectable options presented in the web interface include one or more of: a download option for downloading files from the non-volatile memory device through the network, a file recovery option for recovering deleted files from said non-volatile memory device; a memory wipe option for wiping all data from said non-volatile memory device; and an upload option for uploading files to said non-volatile memory device.

14. A method of indirectly accessing a non-volatile memory device using a computer, said method comprising: (a) in either order, (i) connecting said non-volatile memory device, under restricted file permissions, to a dedicated microcomputer device that is separate from said computer; and (ii) with said dedicated micro-computer device connected to a network, reading from a display of said dedicated micro-computer device an IP address or hostname by which said dedicated micro-computer device is identifiable on said network; and (b) in a web browser of said computer, using said IP address or hostname to access a web interface that is hosted by said dedicated micro-computer device and presents user-selectable options concerning content of the non-volatile memory device.

15. The method of claim 14 further comprising selecting a download option from the user-selectable options, and thereby downloading files from the non-volatile memory device to the computer through the network.

16. The method of claim 14 further comprising selecting a file recovery option from the user-selectable options, and thereby recovering deleted files from said non-volatile memory device.

17. The method of claim 14 further comprising selecting a memory wipe option from the user-selectable options, and thereby wiping all data from said non-volatile memory device.

18. The method of claim 14 further comprising selecting an upload option from the user-selectable options, and thereby uploading files to said non-volatile memory device.

19. The method of claim 14 further comprising selecting an ISO image option from the user-selectable options, and thereby imaging said non-volatile memory device to an ISO image file.

20. The method of claim 14 further comprising selecting a restore ISO image option from the user-selectable options, and thereby restoring an ISO image to said non-volatile memory device.
